(19) United States
(12) Patent Application Publication
(10) Pub. No.: US 2005/0271339 A1
(43) Pub. Date: Dec. 8, 2005

(54) Preform, a head part for a preform and a method for manufacturing a fibre

(75) Inventor: Markku Rajala, Helsinki (FI)

Correspondence Address: VENABLE LLP, P.O. BOX 34385, WASHINGTON, DC, 20045-9998, US

(73) Assignee: Photonium Oy, Lohja As (FI)

(21) Appl. No.: 10/517,632

(22) PCT Filed: Jun. 13, 2003
(86) PCT No.: PCT/FI03/00473

§ 371 Date: Aug. 3, 2005

(30) Foreign Application Priority Data
Jun. 13, 2002 (FI) 20021148

(51) Int. Cl. G02B 6/02

(52) U.S. Cl. 385/123

(57) ABSTRACT

A preform, a head part for a preform and a method for manufacturing a fiber. The head part is adapted to be attached to a preform of a fiber. The head part has such a shape that a heat load directed to the preform will be distributed to the cross section of the bulk part in a predetermined manner, like evenly distributing the heat load to the cross section of the preform. When manufacturing a fiber from a preform including such a head part the heating of the preform is more controllable thus resulting in a fiber with a better quality.

### FIELD OF THE INVENTION

The field of this invention is manufacturing a fibre and a preform used in fibre manufacturing process.

### BACKGROUND OF THE INVENTION

Fibre optics is used in various optical systems. For example in the recent years more and more electrical communication is moved from traditional copper wires relaying electrical current to optical fibres in which the signal is transmitted using pulses of light.

In FIG. 1 the basic operation principle of a traditional optical fibre is presented. At its simplest form the optical fibre 10 comprises a core layer 11 surrounded by a clad layer 12. A total reflection takes place when a beam of light travelling in the core layer 11 hits the boundary between the two layers, but only if the index of reflection of the clad layer 12 on the used wavelength is sufficiently smaller than the index of reflection of the core layer 11. Because of this total reflection the beam of light stays inside the core layer 11, thus allowing the fibre to be used for transmitting light.

Another type of an optical fibre known from the prior art is a fibre that has a non-homogenous region inside i.e. inside a fibre there is a region where some of the characteristics of a fibre are not constant. One example of such non-homogenous regions is the “holey in a fibre”-type construction described below.

In the FIG. 2 a method according to U.S. Pat. No. 5,802,236 for manufacturing a “holey in a fibre”-type optical fibre. In the “holey in a fibre”-type fibre the difference of index of reflections which causes the total reflection is caused by small pipes 21 that have been placed around the core layer 22. During the manufacturing process the diameter of these so called capillary pipes is contracted so that the light travelling in the fibre does not “see” the pipes as individual boundaries anymore, but as changes in the index of reflection. This is because part of the light penetrates into the capillary pipes and “sees” the index of reflection of the material inside the pipe e.g. air with n=1.0. Thus the “holey in a fibre”-type fibre can also be used for transmitting light.

By placing these capillary pipes with a predetermined manner around the core layer a change in the index of reflection is achieved even if same bulk material is used in both layers. In the traditional optical fibres the core and clad layers are made of different materials.

Manufacturing “holey in the fibre”-type optical fibres is quite a challenging task. For a fibre to work as planned the holes in the pipes must maintain their size and tolerance throughout the length of the whole fibre. Fibres with holes of reasonable size when compared to the diameter of the fibre can be manufactured by drilling holes in a cylindrical preform and pulling this cylinder in order to form a fibre. Another way also known from prior art is to manufacture a preform by packing pipes made of glass or other suitable material to a bundle and pulling the preform in order to form a fibre.

As told above the preform used to manufacture “holey in a fibre”-type optical fibres comprises holes, that can be manufactured by any means known as such to a man skilled in the art, e.g. the two ways described above. These holes contain some medium, typically air. If the preform has a large number of holes, the fibre could have quite different characteristics when compared to a fibre without holes. This difference must be considered in various steps in the fibre manufacturing process.

When a fibre is pulled from a preform, a preform is typically heated in an oven having cylindrical heating elements directing the heat load to the preform placed along the axis of the oven. The main heat transfer mechanism is radiation, i.e. the electromagnetic radiation radiating from the heating element is absorbed in the preform and thus heating the preform. As the bulk material of the preform, e.g. glass, has typically quite different characteristics than the medium; e.g. air, in the holes the heat is not absorbed uniformly and thus non-homogenous heating is produced.

In the FIG. 3 a prior art system for pulling a fibre is presented. A preform 31 is placed along the symmetry axis of the heating elements 39 forming a cylinder. Pulling is done along the symmetry axis of the cylinder.

When a new preform is placed in the oven a pulling mean 34 is connected to the head surface 33 of the preform. When the heat load from the heating elements 39 causes the head surface 33 of the preform 31 to change into a more viscose state, a pull from the pulling mean 34 causes the fibre to emerge from the preform (thus the term “pulling a fibre”).

Due to the cylindrical shape of the oven the heat load from the heat elements 39 is mostly directed to preform surfaces 35 parallel to the said elements 39. Heat load directed to the head surface 33 of the preform, which is typically aligned perpendicularly to the cylinder axis of the elements, is significantly smaller than the heat load to the preform surfaces 35 parallel the heat elements 39. This uneven heat load causes uneven temperature profile across the cross-section of the head surface, the temperature near the axis being lower than the temperature on the outer regions of the preform.

The non-uniform heating is a problem of the prior art. Non-uniform heating makes the manufacturing process difficult to control, specially when producing “holey in a fibre”-type fibres, where both disadvantages of the prior art described above are present. Due to these factors the yield in a process making “holey in a fibre”-type fibres is typically significantly smaller than in the process of making traditional optical fibres.

### SUMMARY OF THE INVENTION

It is an object of this invention to overcome the disadvantages of the prior art. With an embodiment according to this invention the manufacturing process is easier to control than a prior art process. With improved quality control the overall yield will increase. Thus with this invention high quality fibres are more economical to manufacture than with the prior art solution.

In one embodiment of a preform according the invention, a head part is attached to a bulk part of a preform. Said head part has such a shape that a heat load directed to said preform will be distributed over the cross section of said bulk part in a predetermined manner. This would give a possibility to have an improved control over the temperature profile of the preform, which would help to overcome the problems of the prior art. In one embodiment the shape of said head part is such that said heat load is more evenly distributed to said cross section that it would be without said head part.

In another embodiment the head part is at least partly cone-shaped. A cone-shaped head part would be a geometrically simple to manufacture, but still providing the effect of distributing the heat load evenly over the cross section of the said preform.

In one embodiment the whole cross section of said head part facing said bulk part is substantially equal to the cross section of said bulk part. The cross section of said head part opposite to said cross section facing the bulk part is smaller than said cross section facing the bulk part.

In one embodiment said head part can be manufactured of amorphous material. In other embodiment the material of said head part is compatible with the material of said bulk part. Some possible compatible combinations for said head and bulk part materials comprise (material of the head part named first) glass-quartz, glass-phosphate glass and glass-fluoride glass. Some of the materials used can be doped to achieve modifications to their characteristics.

In one embodiment some heat absorption material is added to the head part to increase the heat absorption.

Said head part and said bulk part can be joined together e.g. by process of melting and solidifying or by using a mechanical joint.

In one embodiment said bulk part comprises at least one non-homogenous region to produce a desired variation to the characteristics of the fibre. Non-homogenous region could comprise e.g. holes, amorphous material with an index of reflection different than the index of reflection of the main material used in said bulk part or amorphous material that is doped with rare earth.

### BRIEF DESCRIPTION OF THE DRAWINGS

In the following a present invention will be described in more detail with the reference to the appended figures, in which

FIG. 1 illustrates a basic operation principle of a traditional optical fibre,

FIG. 2 illustrates schematically a “holey in a fibre”-type optical fibre,

FIG. 3 illustrates a prior art system for pulling a fibre, and

FIG. 4 an embodiment of the invention based on a cone-shaped head part,

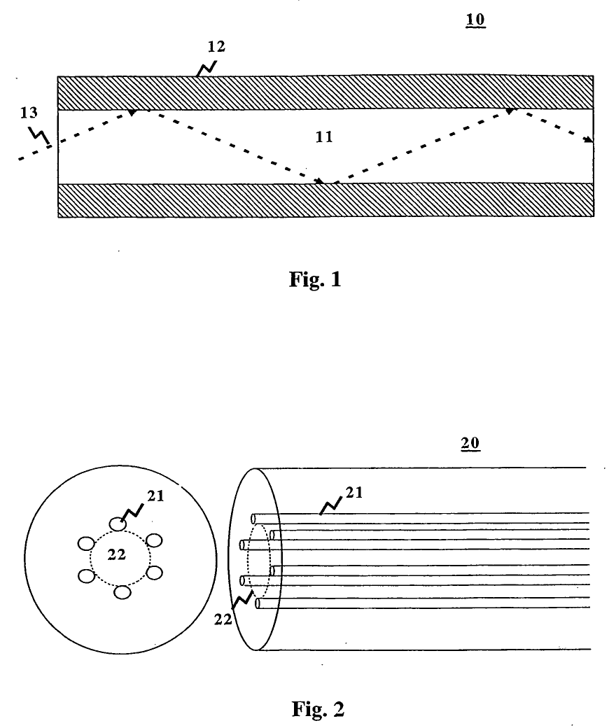

FIGS. 1, 2 and 3 have been described in relation to prior art.

### DETAILED DESCRIPTION OF THE PREFERRED EMBODIMENTS

In the following some embodiments of the present invention are presented. These embodiment are exemplary in nature and are not to be interpreted as limiting the scope of protection to only those specific embodiments shown.

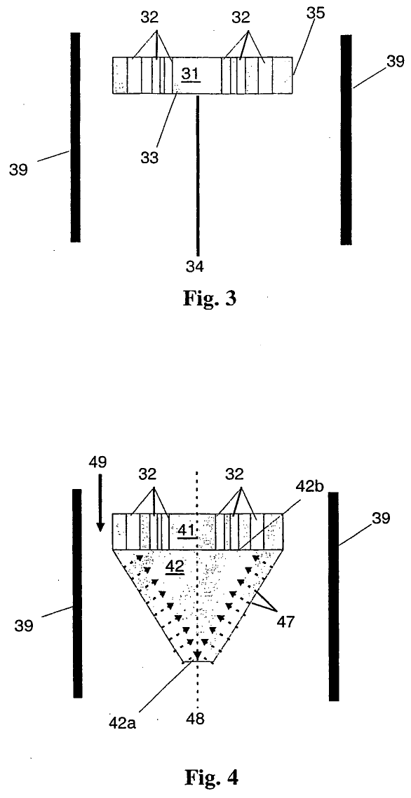

In FIG. 4 an embodiment of the present invention is presented. A preform having a bulk part 41 similar to one presented in FIG. 3 is placed inside an oven having heating elements 39 producing the heat load that increase the viscosity of the preform 41. In this embodiment a cone-shaped head part 42 is attached to the bulk part 41.

If the preform is moved to a hot region of the oven from the direction of arrow 49 the head part 42 will enter the hot region before the bulk part 41. Thus the head part 42 starts warming up before the bulk part 41.

The heat load absorbing to the outer part of the material of the head part 42 heats the material and the convection adds an additional heat load to the inner part of the head part 42, as shown by arrows 47 in the FIG. 4. Because of the narrower end 42a of the head part 42, a greater heat load per volume is directed to the narrower end 42a than to the wider end 42b closer to the bulk part. This results in a greater heat load to the axis 48 than if the head part 42 would have a cylinder shape, causing a more uniform temperature profile over the cross section of the head part 42 and eventually also the bulk part 41. In another words the head part 42 distributes the heat load directed to it uniformly to the bulk part 41. Thus the solution removes the disadvantages of the prior art.

The idea presented is not limited to producing even temperature profiles, but a head part with a different shape could also be made to produce some other predetermined temperature profile.

The head part 42 presented in FIG. 4 is a truncated cone. However, the head part 42 distributing the heat to the bulk part 41 could also be manufactured to other shapes than cones or truncated cones.

In the embodiment presented in FIG. 4 the cross-section 42b of the head part 42 facing the bulk part 41 is substantially equal to the cross-section of bulk part 41. The cross-section 42a, opposite to the said cross-section 42b, is smaller than said cross-section 42b facing the bulk part 41. For some other embodiments the cross-section of the head part 42 could as be greater or smaller than the cross-section of the preform.

As the head part 42 and the bulk part 41 are connected to each other to form a preform used for pulling a fibre it is advantageous that the bulk part 41 and the head part 42 are made of compatible materials. Head part 42 could comprise glass or another amorphous material and the bulk part could comprise e.g. quartz, phosphate glass, or fluoride glass. Each material mentioned could be either pure or doped with suitable dopant material, the head part 42 could comprise for example some heat absorbing material for increasing the amount of heat absorbing in the head part 42.

The head part 42 and the bulk part 41 could be connected to each other e.g. by welding, i.e. process comprising steps of melting and solidifying. It is specially noted that it is not necessary that the parts are connected on the whole diameter of the joint.

Another possibility to combine head part 42 with the bulk part 41 is that a mechanical join is manufactured, so that surfaces are locked to each other when combined.

If a variation of some of the characteristic inside a fibre is needed, this could be carried out by producing at least one non-homogenous region into the fibre. This non-homogenous region could comprise e.g. holes, an amorphous material with an index of reflection difference than the index of reflection of the main material used in said bulk part or amorphous material that is doped with rare earth. The invention presented is well suited for manufacturing this kind of fibres as the manufacturing processes in this case are typically more difficult to control than the conventional fibre manufacturing processes due to the non-homogenous structure of the fibres

It is to be understood that although the present invention has been specially disclosed with preferred embodiments and examples, modifications to these may be apparent to a man skilled in the art and such modifications and variations are considered to be within the scope of the invention and the appended claims. It is also intended that all the matter contained in the above description shall be interpreted as illustrative and not in a limiting sense.

1. A preform used for pulling a fiber, comprising a bulk part and a head part and the head part is attached to the bulk part, wherein the head part comprises a narrower end and a wider end, and the wider end of the head part is connected to the bulk part, wherein a heat load directed to said preform will be distributed to the cross section of said bulk part in a predetermined manner.

2. The preform according to claim 1, wherein said head part is at least partly cone shaped.

3. The preform according to claim 1, wherein said head part comprises amorphous material.

4. The preform according to claim 1, wherein said head part and said bulk part are made of compatible materials.

5. The preform according to claim 4, wherein said bulk part comprises pure or doped quartz and said head part comprises glass.

6. The preform according to claim 4, wherein said bulk part comprises pure or doped phosphate glass and said head part comprises glass.

7. The preform according to claim 4, wherein said bulk part comprises pure or doped fluoride glass and said head part comprises glass.

8. The preform according to claim 1, wherein said head part comprises material increasing the heat absorption.

9. The preform according to claim 1, wherein said head part and said bulk part are at least partly joined together by process of melting and solidifying.

10. The preform according to claim 1, wherein said head part and said bulk part are at least partly joined together by a mechanical joint.

11. The preform according to claim 1, wherein cross-section of said head part on the side facing said bulk part is substantially equal to the cross-section of said bulk part and the cross-section of said head part opposite to said bulk part is smaller than said cross-section facing said bulk part.

12. The preform according to claim 1, wherein said bulk part comprises at least one non-homogeneous region.

13. The preform according to claim 12, wherein said at least one non-homogeneous region comprises a hole.

14. The preform according to claim 12, wherein said at least one non-homogeneous region comprises an amorphous material with an index of reflection difference than the index of reflection of the main material used in said bulk part.

15. The preform according to claim 12, wherein said at least one non-homogeneous region comprises an amorphous material that is doped with rare earth.

16. A head part for a preform of a fiber, the head part comprising: a narrower end and a wider end, and the wider end of the head part can be connected to the bulk part, wherein a heat load directed to said preform will be distributed to the cross section of said bulk part in a predetermined manner.

17. The head part according to claim 16, wherein said head part is at least partly cone shaped.

18. The head part according to claim 16, wherein said head part comprises amorphous material.

19. The head part according to claim 16, wherein said head part comprises material increasing the heat absorption.

20. A method for manufacturing a fiber from a perform that comprises a bulk part and a head part is attached to the bulk part, the method comprising:
heating a preform so that a surface of the preform is at least partly transformed to a form suitable for pulling a fiber and
directing a pulling effect to at least the transformed part of the preform, and
controlling at least in the beginning of the heating process at least a part of a heat load directed to said preform by a head part comprising a narrower end and a wider end wherein the wider end of the head part is attached to the bulk part.

21. The method according to claim 20, wherein said step of controlling is such that the heat load is more evenly distributed to the cross section of said surface that it would be without said head part.

22. The method according to claim 20, wherein said head part is at least partly cone shaped.

23. The method according to claim 20, further comprising: joining at least partly said head part to a bulk part of said preform.

24. The method according to claim 23, wherein said step of joining precede said step of heating.

25. The method according to claim 23, wherein said step of joining further comprises steps of melting and solidifying.
